(19) United States
(12) Patent Application Publication
(10) Pub. No.: US 2022/0305583 A1
(43) Pub. Date: Sep. 29, 2022

(54) WELDING METHOD

(71) Applicant: KABUSHIKI KAISHA TOSHIBA, Tokyo (JP)

(72) Inventor: Tetsuo SAKAI, Taito (JP)

(73) Assignee: KABUSHIKI KAISHA TOSHIBA, Tokyo (JP)

(21) Appl. No.: 17/470,605

(22) Filed: Sep. 9, 2021

(30) Foreign Application Priority Data
Mar. 24, 2021 (JP) 2021-049528

(51) Int. Cl. B23K 26/12; B23K 26/26; B23K 26/32

(52) U.S. Cl. CPC B23K 26/125; B23K 26/26; B23K 26/32; B23K 2103/10

(57) ABSTRACT

According to one embodiment, a welding method includes preparing a welding member that includes aluminum. The welding method includes welding a weld area of a surface of the welding member by irradiating a laser on the weld area in a state in which a gas including oxygen is supplied to the weld area. A concentration of the oxygen in the gas is not less than 1.5 vol % and not more than 10 vol %. The weld area includes aluminum oxide after the irradiating of the laser.

### CROSS-REFERENCE TO RELATED APPLICATIONS

This application is based upon and claims the benefit of priority from Japanese Patent Application No. 2021-049528, filed on Mar. 24, 2021; the entire contents of which are incorporated herein by reference.

### FIELD

Embodiments described herein relate generally to a welding method.

### BACKGROUND

For example, a housing of a battery or the like is manufactured by welding. It is desirable to improve the quality of the welding.

### BRIEF DESCRIPTION OF THE DRAWINGS

FIG. 1 is a schematic perspective view illustrating a welding method according to a first embodiment;

FIG. 2 is a flowchart illustrating the welding method according to the first embodiment;

FIGS. 3A and 3B are schematic views illustrating a weld state;

FIGS. 4A and 4B are schematic views illustrating a weld state;

FIGS. 5A and 5B are schematic views illustrating weld states;

FIGS. 6A to 6C are graphs illustrating evaluation results of welding; and

FIGS. 7A to 7I are photographs illustrating weld states.

### DETAILED DESCRIPTION

According to one embodiment, a welding method includes preparing a welding member that includes aluminum. The welding method includes welding a weld area of a surface of the welding member by irradiating a laser on the weld area in a state in which a gas including oxygen is supplied to the weld area. A concentration of the oxygen in the gas is not less than 1.5 vol % and not more than 10 vol %. The weld area includes aluminum oxide after the irradiating of the laser.

According to one embodiment, a power generation element includes an element part includes a first conductive member, a second conductive member, and a plurality of first structure bodies. The first structure bodies are located between the first conductive member and the second conductive member. One of the first structure bodies includes a first portion and a second portion. The second portion is between the first portion and the second conductive member. The first portion is chemically bonded with the first conductive member. The second portion abuts the second conductive member.

Exemplary embodiments will now be described with reference to the drawings.

In the specification of the application and the drawings, components similar to those described in reference to a drawing thereinabove are marked with like reference numerals; and a detailed description is omitted as appropriate.

### FIRST EMBODIMENT

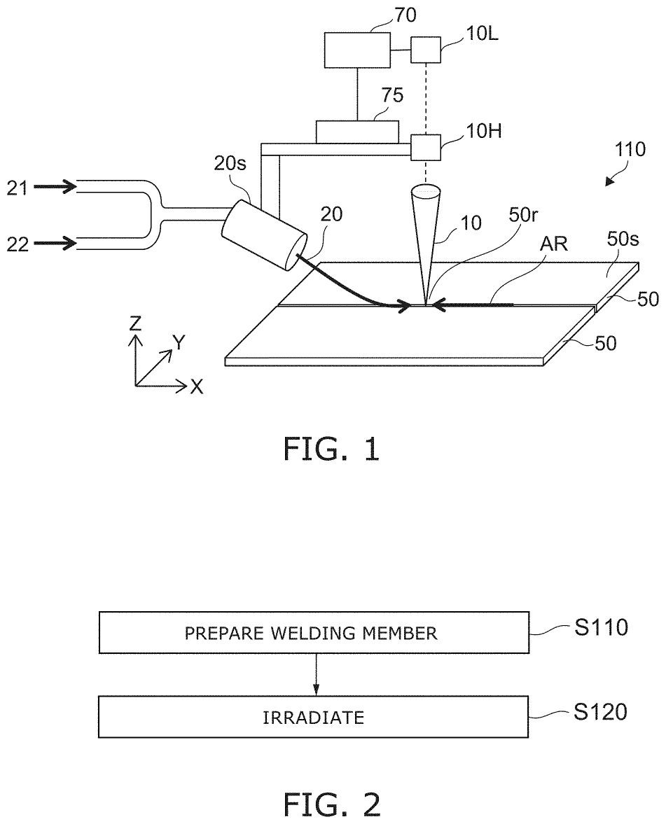

FIG. 1 is a schematic perspective view illustrating a welding method according to a first embodiment.

FIG. 2 is a flowchart illustrating the welding method according to the first embodiment.

In the welding method according to the embodiment as shown in FIG. 1, a laser 10 is irradiated on a welding member 50 in a state in which a gas 20 is supplied to the welding member 50. For example, the welding method according to the embodiment is performed using a welding device 110.

The welding device 110 may include, for example, a laser emitter 10L, an irradiation head 10H, a gas supplier 20s, a driver 75, a controller 70, etc. The laser emitter 10L emits the laser 10 (the laser light). The laser 10 is irradiated on the welding member 50 via the irradiation head 10H. For example, the irradiation head 10H supports the gas supplier 20s. The gas 20 is supplied from the gas supplier 20s toward the welding member 50. The driver 75 is configured to modify the relative position between the irradiation head 10H and the welding member 50. The driver 75 is configured to scan the irradiation head 10H. The controller 70 controls at least one of the laser emitter 10L, the irradiation head 10H, the gas supplier 20s, or the driver 75.

For example, the welding member 50 includes aluminum. The welding member 50 may further include at least one selected from the group consisting of Si, Fe, Cu, Mn, Mg, Cr, Zn, Ti, V, Bi, Pb, and Zr. The aluminum composition ratio in the welding member 50 is not less than 90 wt %. For example, multiple portions of the welding member 50 are joined by welding.

A plane along at least a portion of a surface 50s of the welding member 50 is taken as an X-Y plane. A direction perpendicular to the X-Y plane is taken as a Z-axis direction. For example, the irradiation head 10H is scanned with respect to the welding member 50 along a direction AR in the plane (the X-Y plane) along the surface 50s. In the scanning, the irradiation head 10H may move; and the welding member 50 may move. The direction AR is, for example, an X-axis direction.

According to the embodiment, the laser 10 is irradiated on a weld area 50r of the surface 50s of the welding member 50 in a state in which the gas 20 including oxygen is supplied to the weld area 50r. The weld area 50r is welded thereby.

The gas 20 includes oxygen 21. Another gas 22 also is included. The other gas 22 includes, for example, at least one selected from the group consisting of nitrogen and argon. The other gas 22 may be air.

According to the embodiment, the concentration of the oxygen 21 in the gas 20 is not less than 1.5 vol % and not more than 10 vol %. When the other gas 22 is air, the concentration of the oxygen 21 that includes the component of oxygen included in the air is calculated. It was found that good welding is possible for such a concentration of the oxygen 21. In this specification and the drawings, “vol %” relating to the concentration of a gas may be abbreviated as “%”.

As shown in FIG. 2, the welding method according to the embodiment includes preparing the welding member 50 that includes aluminum (step S110).

As shown in FIG. 2, the welding method according to the embodiment includes welding the weld area 50r by irradiating the laser 10 on the weld area 50r of the surface 50s of the welding member 50 in a state in which the gas 20 that includes the oxygen 21 is supplied to the weld area 50r (step S120). According to the embodiment, the concentration of the oxygen 21 in the gas 20 is not less than 1.5 vol % and not more than 10 vol %.

The welding method according to the embodiment may further include preparing the gas 20 by mixing the oxygen 21 and the other gas 22.

Examples of weld states will now be described.

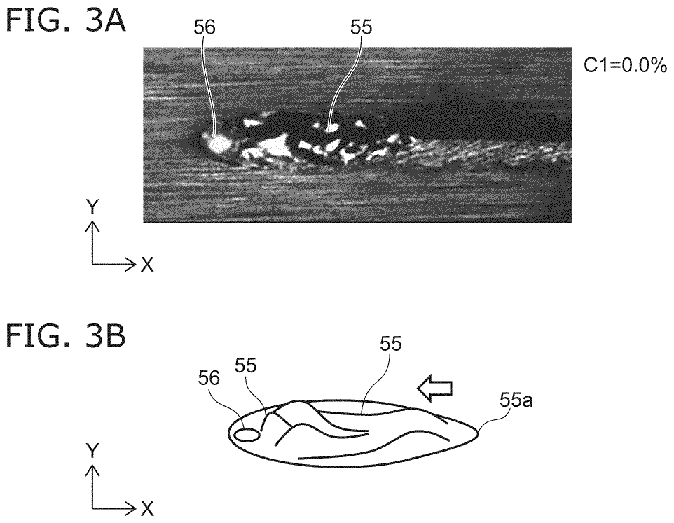

FIGS. 3A and 3B are schematic views illustrating a weld state.

In these drawings, the gas 20 does not include the oxygen 21. The gas 20 substantially includes only nitrogen. A concentration C1 of the oxygen 21 in the gas 20 is 0.0vol %. FIG. 3A is an optical microscope photograph of the weld area 50r when welding. FIG. 3B is a schematic view drawn based on the optical microscope observation result. The flow rate of the gas 20 is 30 L/minute (liter/minute).

In the weld area 50r as shown in FIGS. 3A and 3B, a wave 55 of the welding member 50 that is a liquid due to the irradiation of the laser 10 is generated. The wave 55 moves from an end portion 55a toward a keyhole 56. It is considered that the movement is based on, for example, Marangoni convection. A portion of the wave 55 covers a portion of the keyhole 56. When the wave 55 enters a portion of the keyhole 56, the shape of the keyhole 56 is disturbed by oscillations of the liquid surface. The laser 10 undergoes multiple reflections and is irradiated inside the keyhole 56; and the liquid welding member 50 is scattered by the vapor pressure. For example, sputtering occurs. Thereby, the weld becomes unstable. Welding defects easily occur. For example, the quality of the weld easily degrades.

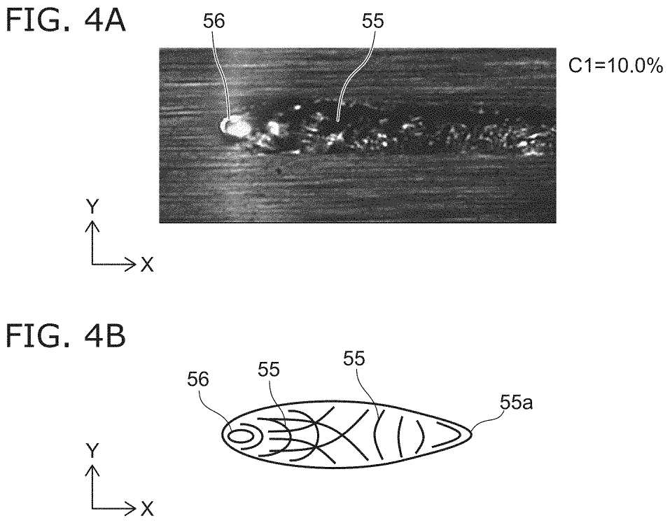

FIGS. 4A and 4B are schematic views illustrating a weld state.

In these drawings, the gas 20 includes the oxygen 21 and nitrogen. The concentration Cl of the oxygen 21 in the gas 20 is 10.0 vol %. FIG. 4A is an optical microscope photograph of the weld area 50r when welding. FIG. 4B is a schematic view drawn based on the optical microscope observation result. The flow rate of the gas 20 is 30 L/minute.

In the weld area 50r as shown in FIGS. 4A and 4B, the movement of the wave 55 of the welding member 50 that is a liquid due to the irradiation of the laser 10 is slight. For example, Marangoni convection substantially does not occur. Therefore, a portion of the wave 55 is prevented from covering a portion of the keyhole 56. Sputtering is suppressed. The weld is stabilized thereby. Welding defects can be suppressed. For example, a high-quality weld is obtained.

As described above, the movement of the wave 55 is suppressed when the gas 20 includes the oxygen 21. It is considered that the suppression of the movement of the wave 55 is caused by a portion of the aluminum included in the welding member 50 being oxidized by the oxygen 21. It is considered that the movement of the liquid welding member 50 can be suppressed because the melting point of aluminum oxide is high.

Thus, according to the embodiment, the movement of the wave 55 can be suppressed by the gas 20 including the oxygen 21. For example, the weld area 50r includes aluminum oxide after the laser 10 is irradiated. According to the embodiment, a welding method can be provided in which the quality can be improved.

For example, a reference example may be proposed in which welding of a steel material having iron as a major component is performed using a shielding gas that includes oxygen. An object of the reference example is to omit the heat treatment after welding or to improve the flowability of the melted metal.

Conversely, according to the embodiment, welding of the welding member 50 that includes aluminum is performed. Generally, when welding a material that includes aluminum, a gas that includes oxygen is not used. This is because it had been considered that oxidization should be avoided because the characteristics may change due to oxidization of the material that includes aluminum.

The gas 20 that includes the oxygen 21 according to the embodiment generally is not used when welding a material that includes aluminum. For example, the gas 20 that includes the oxygen 21 is utilized to stabilize the aluminum oxidization of the weld. Thereby, a stable weld is possible as described above. The novel effect of the movement of the wave 55 being suppressed by the gas 20 that includes the oxygen 21 is utilized. This effect is different from the effect when a shielding gas that includes oxygen is used to weld a steel material.

According to the embodiment, the characteristics degrade if the concentration of the oxygen 21 is excessively high. Therefore, the concentration C1 of the oxygen 21 in the gas 20 is set to be not more than 10 vol %. Excessive oxidization is suppressed thereby, and a good-quality weld is obtained. Examples of the concentration C1 of the oxygen 21 will now be described.

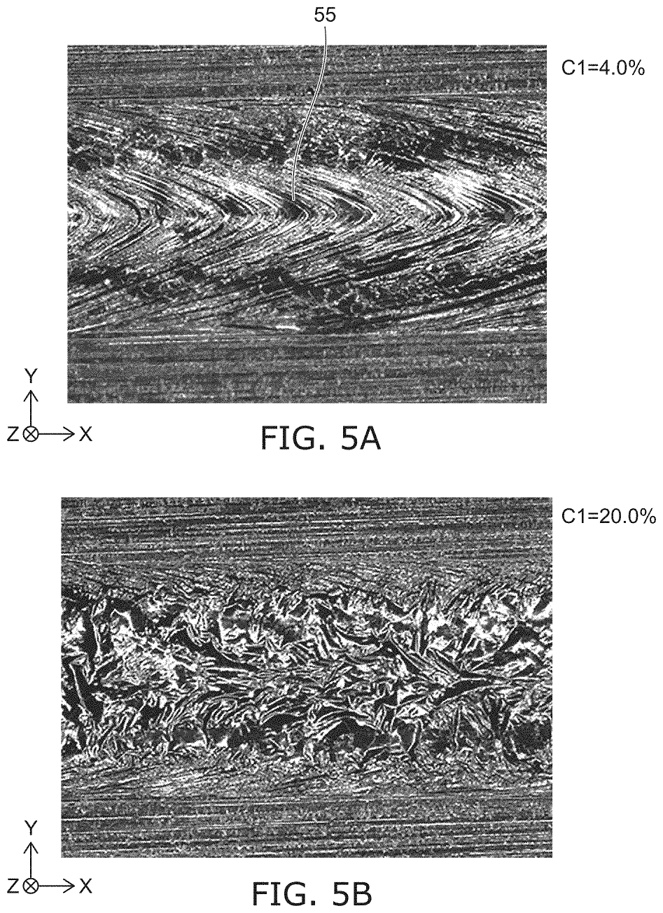

FIGS. 5A and 5B are schematic views illustrating weld states.

These figures illustrate microscope observation images of the welding member 50 after welding. In FIG. 5A, the concentration C1 of oxygen is 4.0 vol %. In FIG. 5B, the concentration C1 of oxygen is 20.0 vol %.

As shown in FIG. 5A, a mark of the wave 55 is distinctly observed when the concentration C1 of oxygen is 4.0 vol %. Multiple waves 55 are arranged along the X-axis direction. The X-axis direction is along the scanning direction (the direction AR (referring to FIG. 1)). A good weld is obtained when the concentration C1 of oxygen is 4.0 vol%.

As shown in FIG. 5B, a mark of the wave 55 is substantially not observed when the concentration C1 of oxygen is 20.0 vol %. A random unevenness is observed. It was found that welding defects occur when the concentration C1 of oxygen is 20.0 vol %. It is considered that this is because the concentration C1 of oxygen is excessively high.

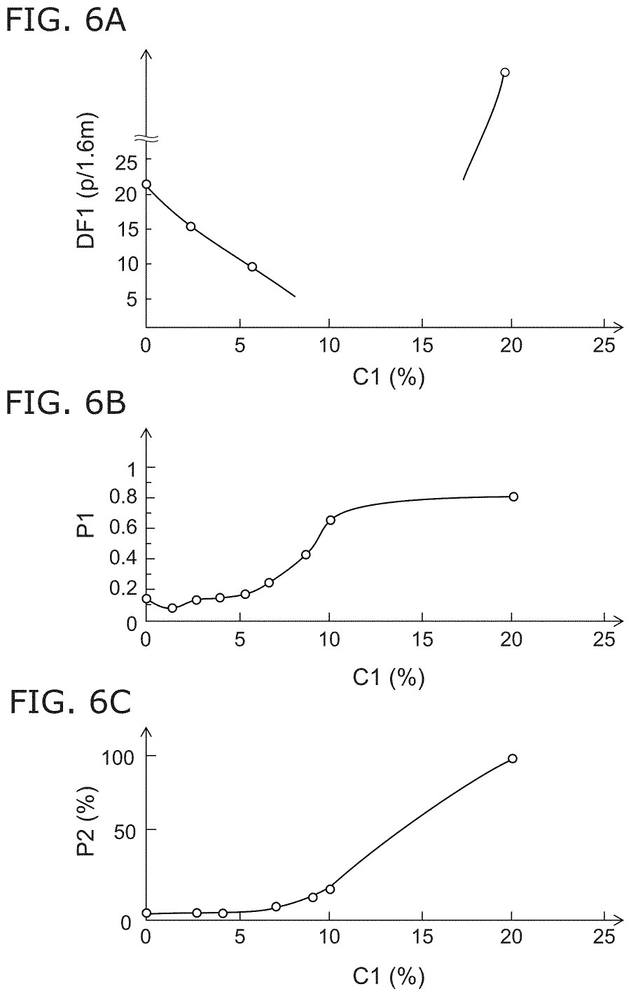

FIGS. 6A to 6C are graphs illustrating evaluation results of the weld.

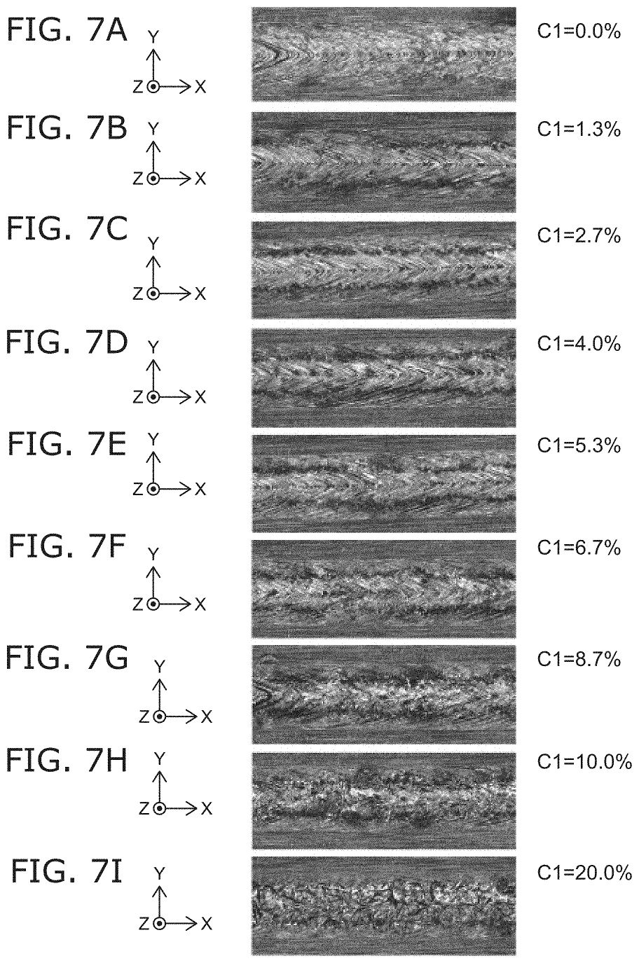

FIGS. 7A to 7I are photographs illustrating weld states.

As shown in FIGS. 7A to 71, the state of the weld portion changes when the concentration C1 of oxygen is changed.

In FIGS. 6A to 6C, the horizontal axis is the concentration C1 of the oxygen 21 in the gas 20. The vertical axis of FIG. 6A is a defect occurrence rate DF1 of the weld. The defect occurrence rate DF1 is the number of defects occurring in a 1.6 m length of the weld. As shown in FIG. 6A, the defect occurrence rate DF1 decreases as the concentration C1 increases in the region in which the concentration C1 of the oxygen 21 is not more than 10 vol %. When the concentration C1 is 20.0 vol %, welding defects occur at many positions of the weld. It is favorable for the concentration C1 of the oxygen 21 to be not less than 1.5 vol %. Welding defects can be reduced.

The vertical axis of FIG. 6B is a first parameter P1 that relates to the oxidization. The optical characteristics (the color or the reflectance) of the weld portion change due to the degree of oxidization. In the example, the first parameter P1 corresponds to the light reflectance in a direction that is oblique to the surface 50s of the welding member 50 (referring to FIG. 1). The degree of oxidization is low when the first parameter P1 is small. The degree of oxidization is high when the first parameter P1 is large. As shown in FIG. 6B, the first parameter P1 becomes large when the concentration C1 of the oxygen 21 is not less than 2.7 vol %. It is considered that the oxidization progresses when the concentration C1 of the oxygen 21 is not less than 2.7 vol %. It is considered that excessive oxidization occurs when the concentration C1 is 20.0 vol %. According to the embodiment, it is favorable for the concentration C1 to be not less than 1.5 vol % and not more than 10 vol %. The weld is stabilized. Welding defects can be suppressed. For example, a high-quality weld is obtained.

The vertical axis of FIG. 6C is a second parameter P2 that relates to the multiple waves 55. As described above, the multiple waves 55 are arranged along the scanning direction when a good weld is obtained (referring to FIG. 5A). The second parameter P2 relates to the uniformity of the arrangement of the multiple waves 55. The second parameter P2 corresponds to the fluctuation of the spacing along the scanning direction of the multiple unevennesses (the waves 55) formed in the weld area 50r. As shown in FIG. 6C, the second parameter P2 is small when the concentration C1 is low. The second parameter P2 increases as the concentration C1 increases. For example, as described with reference to FIG. 5B, a random unevenness is observed when the concentration C1 is 20.0 vol %. In such a case, the second parameter P2 is extremely large. According to the embodiment, it is favorable for the second parameter P2 to be not more than 20%.

Thus, in the welding method according to the embodiment, the relative position between the welding member 50 and the laser 10 in a plane along the surface 50s is caused to change (is scanned) along a first direction (the X-axis direction, i.e., the direction AR). In the example, it is favorable for the fluctuation of the spacing along the first direction of the multiple unevennesses (the waves 55) formed in the weld area 50r to be not more than 20%. The weld is stabilized. Welding defects can be suppressed. For example, a high-quality weld is obtained. From FIG. 6C, it is favorable for the concentration C1 to be not more than 10 vol %.

In one example according to the embodiment, the wavelength of the laser 10 is, for example, not less than 450 nm and not more than 1090 nm. In one example, the output of the laser 10 is, for example, not less than 500 W and not more than 20,000 W. In one example, the rate (the scan rate) of the change (the scanning) of the relative position between the welding member 50 and the laser 10 is, for example, not less than 50 mm/s and not more than 2,000 mm/s.

### SECOND EMBODIMENT

A second embodiment relates to the welding device 110. As described with reference to FIG. 1, the welding device 110 includes, for example, the laser emitter 10L, the irradiation head 10H, the gas supplier 20s, the driver 75, the controller 70, etc. The welding method described in reference to the first embodiment is implemented by the welding device 110. A welding device can be provided in which the quality can be improved.

According to embodiments, a welding method can be provided in which the quality can be improved.

Hereinabove, exemplary embodiments of the invention are described with reference to specific examples. However, the invention is not limited to these specific examples. For example, various modifications made by one skilled in the art in regard to the configurations, sizes, material qualities, arrangements, etc., of components such as lasers, etc., used in welding methods are included in the scope of the invention to the extent that the purport of the invention is included.

Furthermore, any two or more components of the specific examples may be combined within the extent of technical feasibility and are included in the scope of the invention to the extent that the purport of the invention is included.

Moreover, all welding methods that can improve the quality and are practicable by an appropriate design modification by one skilled in the art based on the welding methods that can improve the quality described above as exemplary embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A welding method, comprising:
preparing a welding member, the welding member including aluminum; and
welding a weld area of a surface of the welding member by irradiating a laser on the weld area in a state in which a gas including oxygen is supplied to the weld area,
a concentration of the oxygen in the gas being not less than 1.5 vol % and not more than 10 vol %,
the weld area including aluminum oxide after the irradiating of the laser.

2. The method according to claim 1, wherein
the gas further includes at least one selected from the group consisting of nitrogen and argon.

3. The method according to claim 1, further comprising:
preparing the gas by mixing air and oxygen.

4. The method according to claim 1, wherein
a wavelength of the laser is not less than 450 nm and not more than 1090 nm, and
an output of the laser is not less than 500 W and not more than 20,000 W.

5. The method according to claim 1, wherein
a relative position between the welding member and the laser in a plane along the surface is caused to change, and
a rate of the change is not less than 50 mm/s and not more than 2,000 mm/s.

6. The method according to claim 1, wherein
the concentration of the oxygen in the gas is not less than 2.7 vol %.
